(19) United States
(12) Patent Application Publication
(10) Pub. No.: US 2009/0299970 A1
(43) Pub. Date: Dec. 3, 2009

(54) Social Network for Mail

(75) Inventor: Jean-Michel Rodriguez, Montpellier (FR)

Correspondence Address: Cantor Colburn LLP-IBM Europe, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/140,683

(22) Filed: Jun. 17, 2008

(30) Foreign Application Priority Data
May 27, 2008 (EP) EP08305202.7

(51) Int. Cl. G06F 7/06; G06F 17/30

(52) U.S. Cl. 707/3; 707/E17.014

(57) ABSTRACT

A method for analyzing email data including: parsing a first email into one or more email attributes; searching a social network datastore that stores email attributes of other emails; retrieving history data related to one or more or the email attributes from the social network datastore; and processing the one or more email attributes and the history data based on one or more configurable rules.

### CROSS-REFERENCE TO RELATED APPLICATIONS

This patent application claims priority to EP08305202.7 filed May 27, 2008, which is incorporated herein by reference in its entirety.

### BACKGROUND

1. Field

This disclosure relates to methods, systems, and computer program products for providing a semantic analysis of electronic emails.

2. Description of Background

Electronic mail (email) is now a common form of communication that is used on a daily basis by individuals as well as businesses. In some cases, the individuals and/or businesses receive overwhelming amounts of emails per day. Sifting through the emails to try and determine who is sending the email, why the email is being sent, or if the email relates to other emails can be tedious and time consuming.

After sifting through the emails, in some cases, it is determined that a particular sender should be blocked, for example as a spam sender. In some cases, multiple spam senders can be related. To block all of the spam senders, each spam sender must be blocked individually. This process can be tedious and time consuming.

### SUMMARY

The shortcomings of the prior art are overcome and additional advantages are provided through the provision of a method for analyzing email data. The method includes: parsing a first email into one or more email attributes; searching a social network datastore that stores email attributes of other emails; retrieving history data related to one or more or the email attributes from the social network datastore; and processing the one or more email attributes and the history data based on one or more configurable rules.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution which enhances an email application by providing methods, systems, and computer program products that allow an email user to query and automatically generate statistical data about e-mail content, a sender of an e-mail, a subject of an e-mail, and/or social networks associated with an email.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a block diagram illustrating a network of computers that include a social networking system in accordance with an exemplary embodiment;

FIG. 2 is a dataflow diagram illustrating a social networking application of the social networking system in accordance with an exemplary embodiment; and

FIG. 3 is a flowchart illustrating a social networking method that can be performed by the social networking application in accordance with an exemplary embodiment.

The detailed description explains the preferred embodiments of the invention, together with advantages and features, by way of example with reference to the drawings.

### DETAILED DESCRIPTION

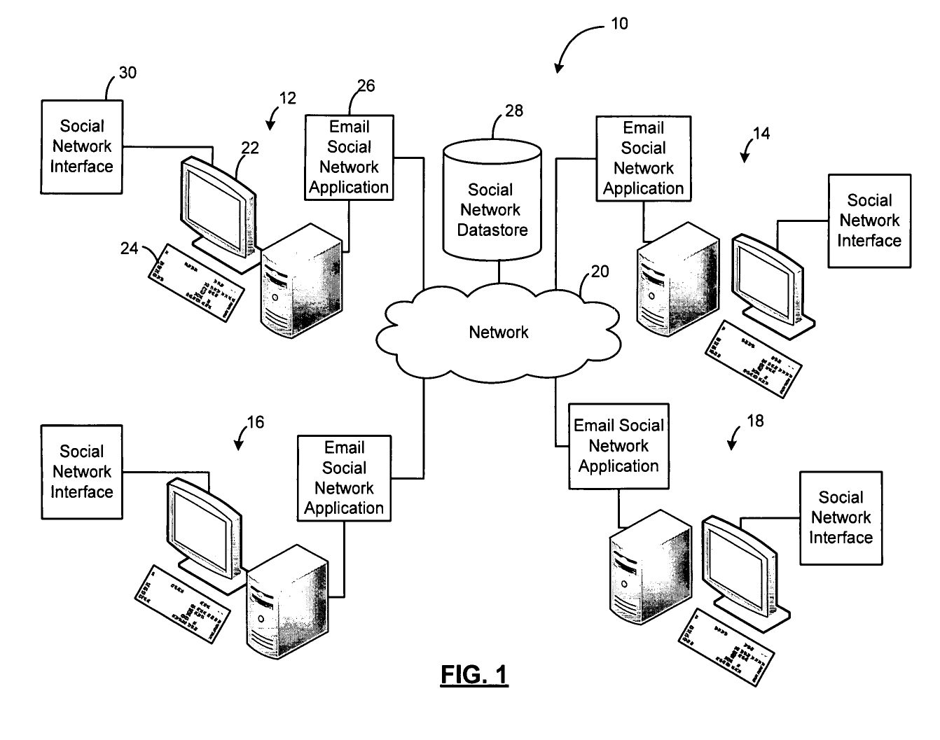

Turning now to the drawings in greater detail, it will be seen that in FIG. 1 a social networking system 10 comprises one or more computers 12-18 that are communicatively coupled via a network 20. As can be appreciated, the network 20 can be any type or combination thereof of known networks including, but not limited to, a wide area network (WAN), a local area network (LAN), a global network (e.g. Internet), a virtual private network (VPN), and an intranet. As can be appreciated, the computers 12-18 can include, but are not limited to, a desktop computer, a laptop, a workstation, a portable handheld device, or any combination thereof.

The one or more computers 12-18 include a processor (not shown) and one or more data storage devices (not shown). The processor can be any custom made or commercially available processor, a central processing unit, an auxiliary processor among several processors associated with the computer, a semiconductor based microprocessor, a macroprocessor, or generally any device for executing instructions. The one or more data storage devices can be at least one of the random access memory, read only memory, a cash, a stack, or the like which may temporarily or permanently store electronic data. The computers 12-18 may be associated with a display device 22 and one or more input devices 24 that may be used by a user to communicate with the computers. As can be appreciated, such input devices 24 may include, but are not limited to, a mouse, a keyboard, and a touchpad.

According to an exemplary embodiment, one or more of the computers 12-18 includes an email social network application 26 that communicates electronic data to and/or from a social network datastore 28. In various embodiments, the social network datastore 28 is a central datastore that is located on one of the computers 12-18 or remotely from the all of the computers. In various other embodiments, the social network datastore 28 includes one or more sub-datastores located on each of the computers 12-18 that communicate user data on a peer-to-peer basis.

The email social network application 26 processes incoming emails, stores the processed email data in the social network datastore 28, and performs one or more analyses on semantically related email data stored in the social network datastore 28. A user communicates with the email social network application 26 and views a result of the one or more analyses via a social network interface 30 displayed on the display device 22. In one example, the email social network application 26 is called on demand by a user inquiring about, for example, a sender, connections (e.g., subjects, topics, other users) associated with the sender, topics covered by the sender, sender history, etc.

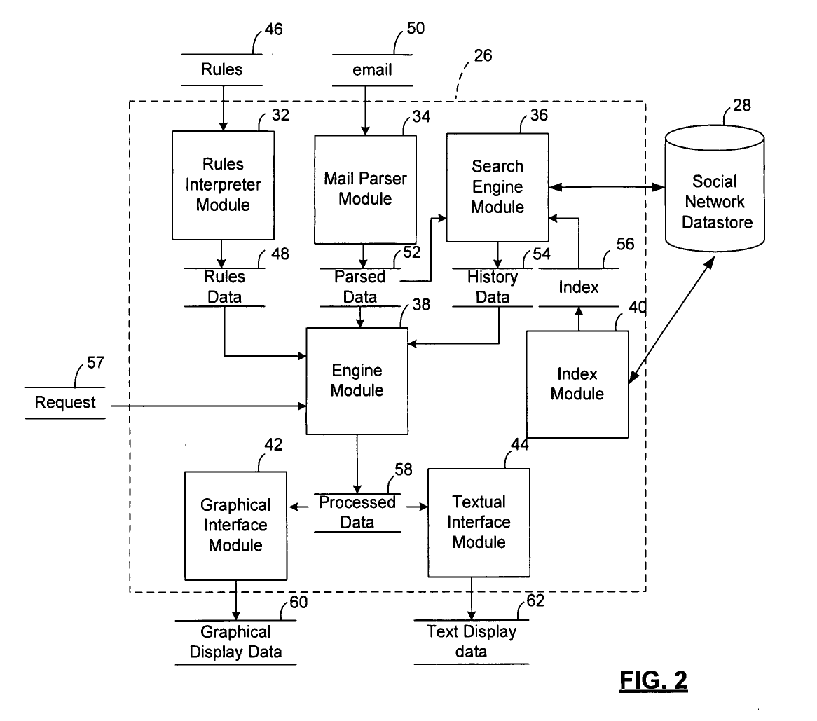

Turning now to FIG. 2, a dataflow diagram illustrates the email social network application 26 of FIG. 1 in accordance with an exemplary embodiment. The email social network application 26 can include one or more modules. As can be appreciated, the modules can be implemented as software, hardware, firmware and/or other suitable components that provide the described functionality. As can be appreciated, the modules shown in FIG. 2 can be combined and/or further partitioned to similarly process email data. In this example, the email social network application 26 includes a mail parser module 32, a rules interpreter module 34, a search engine module 36, an engine module 38, an index module 40, a graphical interface module 42, and a textual interface module 44.

The mail parser module 32 receives as input email 46 sent to a user of the computer 12 (FIG. 1) by other users (e.g., a sender). The mail parser module 32 parsers the email 46 and generates parsed data 48 based on one or more pre-defined parsing rules. The parsing rules can be generally applicable to all email applications and/or applicable to specific email applications. In one example, the parsed data 48 includes, but is not limited to, a sender user name, a sender email address, a list of CC user names, a list of CC email addresses, a subject, mail contents and/or any combination thereof. In various embodiments, the mail parser module 32 stores the parsed data 48 in the social network datastore 28 (relationship not shown). The parsed data 48 can then be used for future analysis by the same or other users.

The rules interpreter module 34 receives as input rules 50 and generates rules data 52 to define how to carryout an inquiry. In various embodiments, the rules 50 are entered by a user via the social network interface 30 (FIG. 1). In one example, the rules data 52 is configured to define a total or partial analysis, a search depth, a subject analysis, a contents analysis, a CC search, a BCC search, and/or any combination thereof.

The search engine module 36 interfaces with the social network datastore 28 to retrieve relevant history data 54 for processing based on the parsed data 48. In one example, the history data 54 includes, but is not limited to, subject, contents, name or list of names, and a connection between other emails. In various embodiments, an index module is provided to assist the search engine module in accessing the history data 54. The index module 40 manages an indexing scheme of the social network datastore 28. Based on the indexing scheme, the index module 40 provides an index 56 to the search engine module 36 for retrieving the relevant history data 54.

The engine module 38 receives as input the parsed data 48, the rules data 52, the history data 54, and a request 57 for social network information. Based on the inputs, the engine module 38 processes the data and generates processed data 58. In one example, the processing module 38 processes the parsed data 48 and the history data 54 based on one or more processing methods. Such methods can include, but are not limited to, methods known in the art, such as, correlation methods, aggregation methods, knowledge tree creation methods, and statistical methods.

The graphical interface module 42 and/or the textual interface module 44 then receive the processed data 58. Based on the processed data 58, the graphical interface module 42 generates a graphical display data 60 that is displayed via the social network interface 30 (FIG. 1). In one example, the graphical display data can include one of graphs, charts, and structures. Based on the processed data 58, the textual interface module 44 generates textual display data 62 that is displayed via the social network interface 30 (FIG. 1).

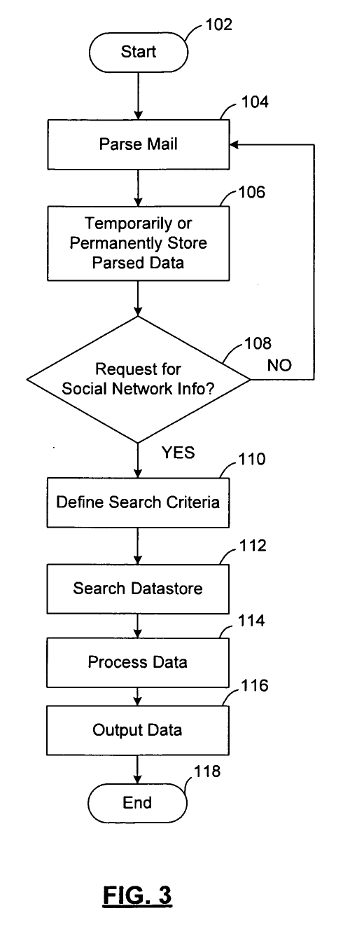

Turning now to FIG. 3 and with continued reference to FIG. 2, a flowchart illustrates an email social network method that can be performed by the email social network application 26 of FIG. 2 in accordance with an exemplary embodiment. As can be appreciated in light of the disclosure, the order of operation within the method is not limited to the sequential execution as illustrated in FIG. 3, but may be performed in one or more varying orders as applicable in accordance with the present disclosure.

In one example, the method may begin at 100. As new emails 46 are received, the new emails 46 are parsed at block 102. The parsed data 48 is temporarily or permanently stored in, for example, the social network datastore 28 at block 104. Thereafter, requests 37 for social network information are monitored at block 106. If a request 37 for social network information is not received, the method loops back and continues to parse new emails 46 at block 102.

However, once the request 37 for social network information is initiated at 106. The search criteria is defined via the rules 50 at block 108. The social network datastore 28 is searched at block 110. The data is processed at block 112. Based on the processing, the processed data 58 is output at block 114, either textually or graphically. Thereafter, the method may end at 116.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for analyzing email data, the method comprising:
parsing a first email into one or more email attributes;
searching a social network datastore that stores email attributes of other emails;
retrieving history data related to one or more or the email attributes from the social network datastore; and
processing the one or more email attributes and the history data based on one or more configurable rules.

2. The method of claim 1 further comprising:
parsing one or more of the other emails into one or more other email attributes; and
storing the one or more other email attributes in the social network datastore.

3. The method of claim 2 wherein the first email is received by a first user and whereon one or more of the other emails are emails associated with one or more other users.

4. The method of claim 1 wherein the processing comprises processing the one or more email attributes and the history data based on at least one of a correlation method, an aggregation method, an knowledge tree creation method, and a statistical method.

5. The method of claim 1 further comprising providing at least one of a graphical display and a textual display including processed data from the processing of the one or more email attributes and the history data.
